(19) United States
(12) Patent Application Publication
(10) Pub. No.: US 2014/0349676 A1
(43) Pub. Date: Nov. 27, 2014

(54) PORTABLE DEVICE AND METHOD OF CONTROLLING A PORTABLE DEVICE

(71) Applicant: FUJITSU LIMITED, Kawasaki-shi (JP)

(72) Inventor: Eiji HASEGAWA, Kawasaki (JP)

(73) Assignee: FUJITSU LIMITED, Kawasaki-shi (JP)

(21) Appl. No.: 14/252,923

(22) Filed: Apr. 15, 2014

(30) Foreign Application Priority Data
May 24, 2013 (JP) 2013-109909

(51) Int. Cl. H04W 64/00

(52) U.S. Cl. CPC H04W 64/00
USPC 455/456.1

(57) ABSTRACT

A portable device includes: a memory; and a processor coupled to the memory and configured to determine whether to perform a process of acquiring information from an external device, based on values of a plurality of indices related to movement of the portable device acquired at different points in time.

### CROSS-REFERENCE TO RELATED APPLICATION

This application is based upon and claims the benefit of priority of the prior Japanese Patent Application No. 2013-109909, filed on May 24, 2013, the entire contents of which are incorporated herein by reference.

### FIELD

The embodiments discussed herein are related to a portable device and a method of controlling a portable device.

### BACKGROUND

In a portable device, such as a smartphone or a digital camera, various applications have been operable in recent years. An application handles various processing operations; however, some of them may be omitted if, when the application operates, a portable device is at the same location as when the application operated previously. For example, for processing such as positioning by using a Global Positioning System (GPS) or the like and Wi-Fi scanning, if, when an application operates, the portable device is at the same location as when that application operated previously, only results equivalent to those obtained when the application operated previously are obtained. Accordingly, a technique has been devised in which if, when an application operates, the portable device is at the same location as when that application operated previously, these processing operations are omitted, so that power saving of the portable device is achieved. Japanese Laid-open Patent Publication No. 2007-215096, which is an example of the related art, discloses a method in which, by using a sensor, a determination is made as to whether a portable device has moved, and positioning is stopped from being carried out if it is determined that the portable device has not moved, so that power used for positioning is reduced.

Generally, it is not easy to make a determination as to whether a portable device has moved on a portable device side. Therefore, false negatives in which although a portable device has moved, the movement is not detected, and false positives in which although a portable device has remained stationary, it is determined that the portable device has moved, often occur. Also, slight motion and so on of a user, for example, cause a situation in which it is difficult to determine whether the portable device has moved or remained stationary. For such a situation, if it is made easier to determine that the portable device has remained stationary, the number of false negatives would increase, whereas if it is made easier to determine that the portable device has moved, the number of false positives would increase. Here, a false negative leads to the fact that desired processing (such as GPS positioning and Wi-Fi scanning) will not be performed. In contrast, a false positive leads to the fact that unnecessary processing will be performed, thereby reducing the effect of power saving.

### SUMMARY

According to an aspect of the invention, a portable device includes:

a memory; and a processor coupled to the memory and configured to determine whether to perform a process of acquiring information from an external device, based on values of a plurality of indices related to movement of the portable device acquired at different points in time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic block diagram of a hardware configuration of a portable device according to a first embodiment;

FIG. 2 is a schematic diagram of functional blocks of the portable device according to the first embodiment;

FIG. 3 is a schematic representation of a time-series-movement-probability data according to the first embodiment;

FIG. 4A is a schematic graph of a baseband conversion table according to the first embodiment;

FIG. 4B is a schematic illustration of an acceleration conversion table;

FIG. 5 is a schematic illustration of a method for calculation of a cumulative movement probability according to the first embodiment;

FIG. 6 is a flowchart of a positioning management process according to the first embodiment;

FIG. 7 is a flowchart of a cumulative-movement-probability calculation process according to the first embodiment;

FIG. 8 illustrates a usage example of a cumulative movement probability according to the first embodiment;

FIG. 9 is a schematic diagram of functional blocks of a portable device according to a second embodiment;

FIG. 10 is a flowchart of a Wi-Fi management process according to the second embodiment;

FIG. 11 is a schematic diagram of functional blocks of a portable device according to a third embodiment; and

FIG. 12 is a flowchart of a positioning management process according to the third embodiment.

### DESCRIPTION OF EMBODIMENTS

A portable device according to an embodiment, upon receipt of an instruction for start of a determination of whether movement of the portable device has occurred (hereinafter sometimes referred to as a “movement determination”), acquires a probability that the portable device has moved (hereinafter referred to as a “movement probability”) at the moment at which the movement determination is performed, for example, based on a value detected by a sensor of the portable device. Therefore, when movement determinations are repeatedly performed, respective movement probabilities at the moments of the movement determinations are stored. Subsequently, the portable device according to an embodiment calculates a cumulative movement probability by accumulating the stored movement probabilities, and determines whether movement of the portable device has occurred, based on the cumulative movement probability. That is, the portable device according to an embodiment does not determine whether movement of the portable device has occurred, based on a movement probability at the moment at which the movement determination is performed.

The reason why whether movement of the portable device has occurred is determined based on a cumulative movement probability is as follows. For example, when the movement probability at a moment in time is 5%, there is no case where it is determined, based on that movement probability, that movement of the portable device has occurred. However, if, even with a movement probability of 5%, all the movement probabilities of 20 movement determinations are 5%, it is considered that movement of the portable device has occurred at some point from start of the first movement determination to the end of the last movement determination.

In embodiments described below, in order to detect the movement of a portable device that occurs at some point within a time section, it is determined based on a cumulative movement probability that movement of the portable device has occurred. Hereinafter, description will be given in detail.

### First Embodiment

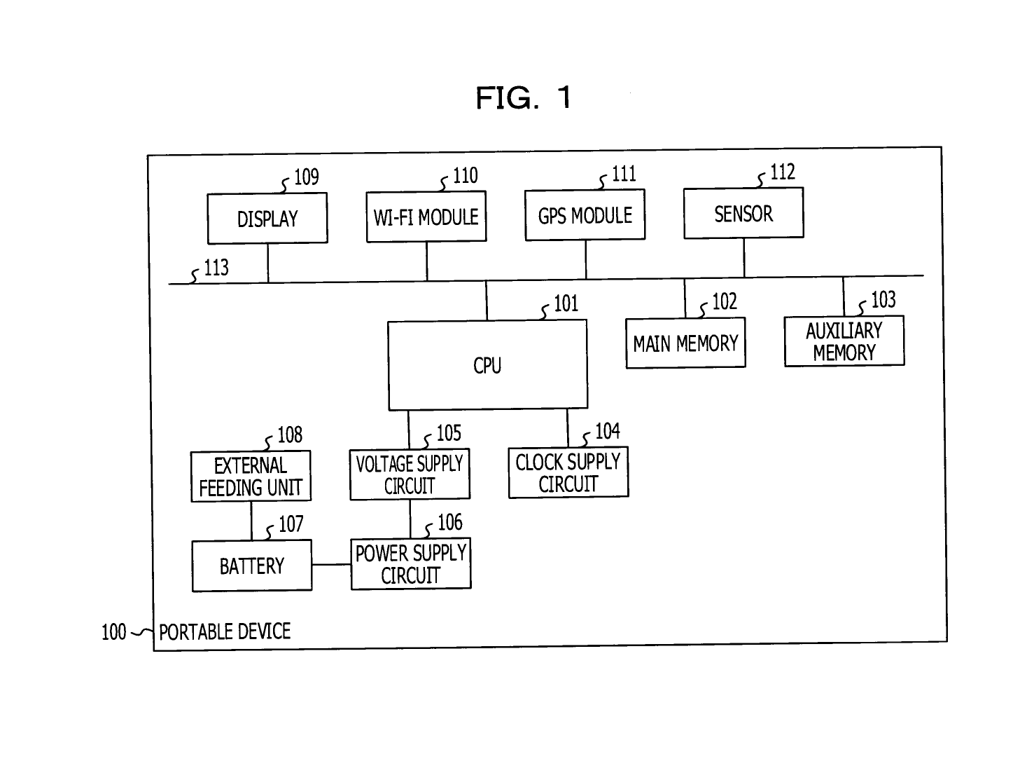

A first embodiment is described below with reference to FIG. 1 to FIG. 8.

[Hardware Configuration of Portable Device 100]

FIG. 1 is a schematic block diagram of a hardware configuration of a portable device 100 according to the first embodiment.

Exemplary examples of the portable device 100 according to this embodiment include, but are not limited to, portable-type information processing devices such as a portable telephone, examples of which include a smartphone, a notebook personal computer (PC) and a tablet PC, and a digital camera.

As illustrated in FIG. 1, the portable device 100 includes a central processing unit (CPU) 101, a main memory 102, an auxiliary memory 103, a clock supply circuit 104, a voltage supply circuit 105, a power supply circuit 106, a battery 107, an external feeding unit 108, a display 109, a Wi-Fi (registered trademark) module 110, a GPS module 111, and a sensor 112, as hardware modules. These hardware modules are coupled by a bus 113.

The CPU 101 operates with a clock signal supplied from the clock supply circuit 104 and a voltage supplied from the voltage supply circuit 105 to control various hardware modules of the portable device 100. Additionally, the CPU 101 loads various programs stored in the auxiliary memory 103 into the main memory 102 and executes the various programs loaded into the main memory 102, thereby implementing various functions. Details of various functions will be described below.

The main memory 102 stores various programs to be executed by the CPU 101. Additionally, the main memory 102 is used as a work area of the CPU 101 and stores various data for processing performed by the CPU 101. A random access memory (RAM), for example, may be used as the main memory 102.

The auxiliary memory 103 stores various programs for causing the portable device 100 to operate. The various programs include, for example, application programs to be executed by the portable device 100, as well as an operating system (OS), which is an execution environment for application programs, and so on. A control program according to this embodiment is also stored in the auxiliary memory 103. A nonvolatile memory, for example, such as a hard disk or a flash memory, may be used as the auxiliary memory 103.

The clock supply circuit 104 generates a clock signal for supply to the CPU 101.

The voltage supply circuit 105 generates a variable voltage for supply to the CPU 101, based on power supplied from the power supply circuit 106.

The power supply circuit 106 supplies power, which is supplied from the battery 107, through power source wires (not illustrated) to various hardware modules of the portable device 100. However, in the case where an external power supply (not illustrated) is coupled to the external feeding unit 108, the power supply circuit 106 may supply power, which is supplied from the external feeding unit 108, to various hardware modules of the portable device 100.

The battery 107 supplies power to the power supply circuit 106. The external feeding unit 108 supplies power, which is supplied from an external power supply, to the battery 107.

The display 109 is controlled by the CPU 101 to present image information to the user of the portable device 100.

The Wi-Fi module 110 is controlled by the CPU 101. The Wi-Fi module 110 searches (scans) for, for example, an access point of wireless local area network (LAN), such as Wi-Fi, and receives access point information sent from that access point.

The GPS module 111 is controlled by the CPU 101. The GPS module 111 receives GPS satellite signals from a plurality of artificial satellites, and calculates position information of the portable device 100 based on a plurality of GPS satellite signals.

The sensor 112 acquires status information of the portable device 100. As the sensor 112, for example, a baseband, Bluetooth (registered trademark), an acceleration sensor, a camera, an illuminance sensor, an atmospheric pressure sensor, a clock, and so on may be used. Note that the “baseband” used here is treated as a sensor that detects the strength of a baseband signal sent from a base station of 3rd Generation (3G) or the like, or the cell ID of a base station.

[Functional Blocks of Portable Device 100]

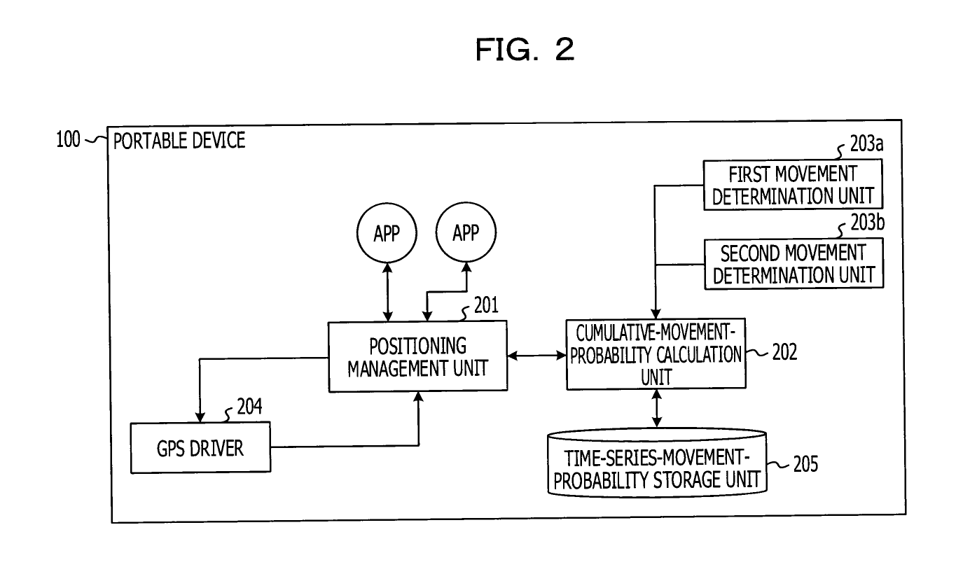

FIG. 2 is a schematic diagram of functional blocks of the portable device 100 according to the first embodiment.

As illustrated in FIG. 2, the portable device 100 according to this embodiment includes a positioning management unit 201, a cumulative-movement-probability calculation unit 202, a first movement determination unit 203a, a second movement determination unit 203b, a GPS driver 204, and a time-series-movement-probability storage unit 205.

The positioning management unit 201, the cumulative-movement-probability calculation unit 202, the first movement determination unit 203a, the second movement determination unit 203b, the GPS driver 204, and the time-series-movement-probability storage unit 205 are all implemented in such a way that the CPU 101 loads a control program into the main memory 102 and executes the control program loaded into the main memory 102.

Note that “App” in the drawing is an application that utilizes position information. Applications App issue positioning requests to the positioning management unit 201 and acquire positioning results (such as position information and error information) from the positioning management unit 201.

(Positioning Management Unit 201)

The positioning management unit 201 receives a positioning request from an application App. Based on a cumulative movement probability acquired from the cumulative-movement-probability calculation unit 202, the positioning management unit 201 instructs the GPS driver 204 to cause the GPS module 111 to start operation. Based on the issuance status of a positioning request of the application App, the positioning management unit 201 instructs the GPS driver 204 to stop operation of the GPS module 111. Additionally, the positioning management unit 201 notifies the application App of positioning results (such as position information and a positioning error) acquired from the GPS driver 204.

(Cumulative-Movement-Probability Calculation Unit 202)

The cumulative-movement-probability calculation unit 202 generates time-series-movement-probability data D described below, based on movement probabilities acquired from the first movement determination unit 203a and the second movement determination unit 203b, and stores the data in the time-series-movement-probability storage unit 205. The movement probability is a movement probability (index for movement) of the portable device 100 at a moment in time. The movement probability may be estimated from a value detected by the sensor 112. The movement probability is a positive number equal to or less than one. Additionally, the cumulative-movement-probability calculation unit 202 calculates a cumulative movement probability of the portable device 100, based on the time-series-movement-probability data D stored in the time-series-movement-probability storage unit 205. The cumulative movement probability is a time-series cumulative value of movement probabilities. The cumulative-movement-probability calculation unit 202 continues cumulative movement probability calculation, based on the time-series movement probability data D, until an instruction to stop cumulative movement probability calculation is given. Details of a method for calculation of a cumulative movement probability will be described below. Each time the cumulative movement probability changes, the cumulative-movement-probability calculation unit 202 notifies the positioning management unit 201 of a cumulative movement probability after the change.

(First Movement Determination Unit 203a)

Based on an instruction for start of a movement determination given from the cumulative-movement-probability calculation unit 202, the first movement determination unit 203a starts to acquire values of baseband signal strength from the sensor 112, and calculates a dispersion value of a variation of the baseband signal strength (an index for a variation of baseband signal strength). Additionally, using a baseband conversion table T1 described below, the first movement determination unit 203a acquires a movement probability corresponding to the dispersion value of a variation of baseband signal strength. The movement probability acquired here is a movement probability of the portable device 100 estimated from a variation of baseband signal strength. Hereinafter, a movement probability acquired by the first movement determination unit 203a is referred to as a “baseband-derived movement probability”. Note that the first movement determination unit 203a continues acquisition of a movement probability of the portable device 100, based on the dispersion value of a variation of baseband signal strength, until an instruction to stop the acquisition is given from the cumulative-movement-probability calculation unit 202. Additionally, each time the movement probability changes, the first movement determination unit 203a notifies the cumulative-movement-probability calculation unit 202 of a movement probability after the change. Note that, although the first movement determination unit 203a notifies the cumulative-movement-probability calculation unit 202 of a movement probability corresponding to the dispersion value of a variation of baseband signal strength, the first movement determination unit 203a may notify the cumulative-movement-probability calculation unit 202 of a movement probability determined in advance, for example, when the baseband base station changes.

(Second Movement Determination Unit 203b)

Based on an instruction for start of a movement determination given from the cumulative-movement-probability calculation unit 202, the second movement determination unit 203b starts to acquire values of acceleration from the sensor 112, and identifies a pattern of detected acceleration. The pattern of detected acceleration includes, for example, the pattern of changes in the absolute value of acceleration. Additionally, using an acceleration conversion table T2 described below, the second movement determination unit 203b acquires a movement probability corresponding to the pattern of detected acceleration. The movement probability acquired here is a movement probability of the portable device 100 estimated from a pattern of detected acceleration. Hereinafter, a movement probability acquired by the second movement determination unit 203b is referred to as an “acceleration-derived movement probability”. Note that the second movement determination unit 203b continues acquisition of a movement probability of the portable device 100, based on a pattern of detected acceleration, until an instruction to stop the acquisition is given from the cumulative-movement-probability calculation unit 202. Additionally, each time the movement probability changes, the second movement determination unit 203b notifies the cumulative-movement-probability calculation unit 202 of a movement probability after the change.

(GPS Driver 204)

The GPS driver 204 turns on or off the GPS module 111, based on an instruction for start or stop of operation from the positioning management unit 201. Additionally, the GPS driver 204 notifies the positioning management unit 201 of a positioning result obtained by the GPS module 111.

(Time-Series-Movement-Probability Storage Unit 205)

The time-series-movement-probability storage unit 205 stores time-series data of movement probabilities acquired by the first and second movement determination units 203a and 203b, that is, the time-series-movement-probability data D. In the time-series-movement-probability data D, each time the movement probability changes, the change time and the movement probability are updated for every sensor. Details of the time-series-movement-probability data D will be described below.

[Time-Series Movement Probability Data D]

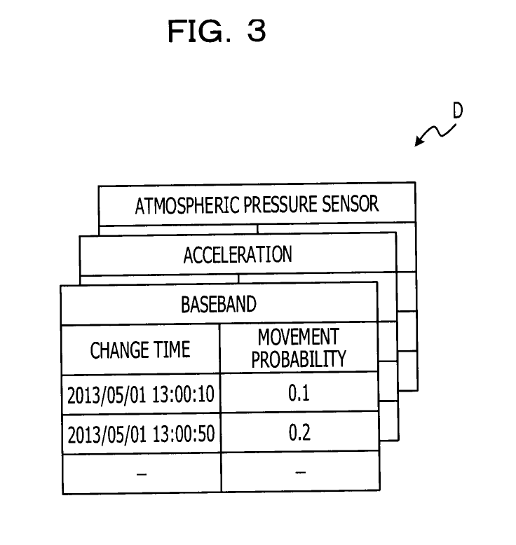

FIG. 3 is a schematic representation of the time-series-movement-probability data D according to the first embodiment.

As illustrated in FIG. 3, the time-series-movement-probability data D according to this embodiment associates the change time of a movement probability with a movement probability after the change for every sensor. That is, as the time-series-movement-probability data D, changes in the movement probability of the portable device 100 are recorded in a time-series manner for every sensor. For example, considering the baseband, it is found that the baseband-derived movement probability changes to “0.1” at a change time “2013/05/01 13:00:10”, and subsequently the baseband-derived movement probability changes to “0.2” at a change time “2013/05/01 13:00:50”. Note that the time-series-movement-probability data D is updated by the cumulative-movement-probability calculation unit 202 each time the movement probability of each sensor changes.

[Baseband Conversion Table T1 and Acceleration Conversion Table T2]

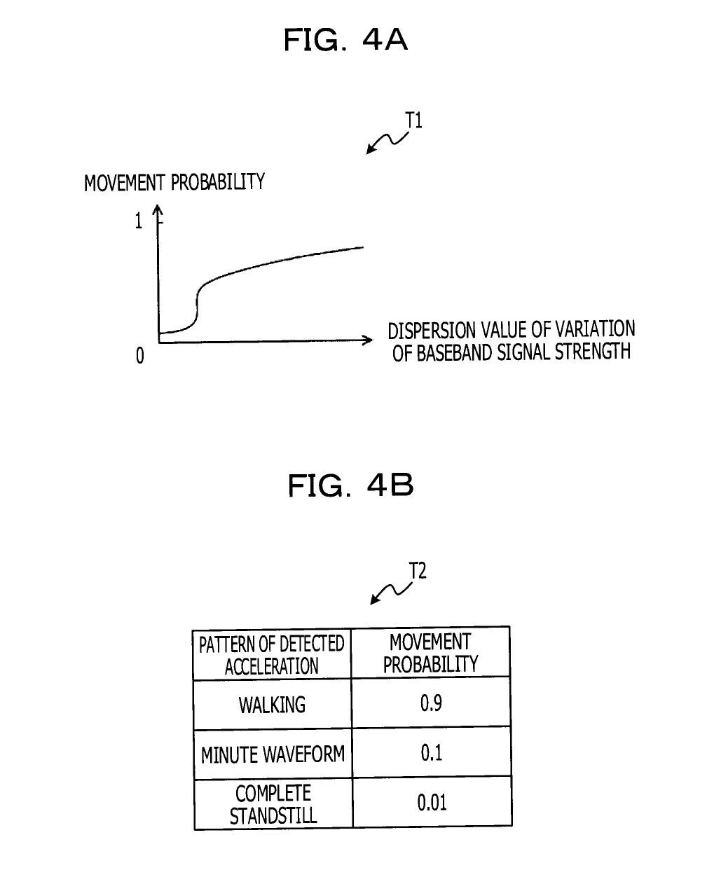

FIG. 4A is a schematic graph of the baseband conversion table T1 according to the first embodiment. FIG. 4B is a schematic illustration of the acceleration conversion table T2.

As illustrated in FIG. 4A, the baseband conversion table T1 associates dispersion values of variations of baseband signal strength with respective movement probabilities (baseband-derived movement probabilities). Likewise, as illustrated in FIG. 4B, the acceleration conversion table T2 associates patterns of detected acceleration with respective movement probabilities (acceleration-derived movement probabilities). Note that the baseband conversion table T1 and the acceleration conversion table T2 are both created in advance and are given, respectively, to the first and second movement determination units 203a and 203b.

[Method for Calculation of Cumulative Movement Probability]

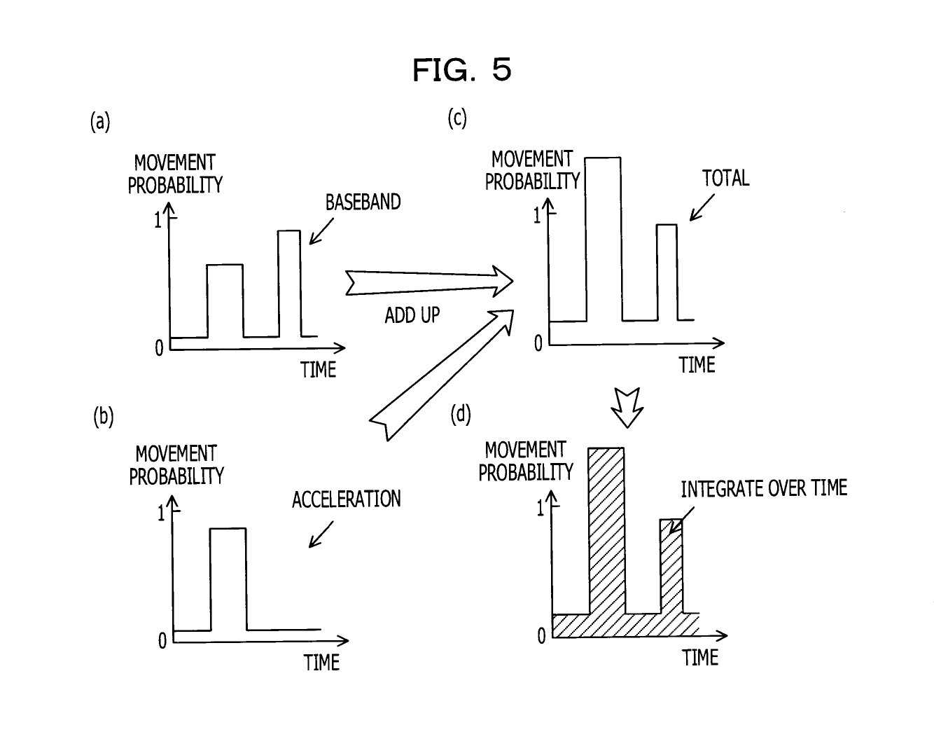

FIG. 5 is a schematic illustration of a method for calculation of a cumulative movement probability according to the first embodiment. The graph in (a) of FIG. 5 illustrates the baseband-derived movement probability, the graph in (b) of FIG. 5 illustrates the acceleration-derived movement probability, the graph in (c) of FIG. 5 illustrates the total of baseband-derived and acceleration-derived movement probabilities, and the graph in (d) of FIG. 5 illustrates the cumulative movement probability. In each graph, the horizontal axis represents time and the vertical axis represents the movement probability.

As illustrated in FIG. 5, the cumulative-movement-probability calculation unit 202 acquires the baseband-derived movement probability (refer to (a) of FIG. 5) and the acceleration-derived movement probability (refer to (b) of FIG. 5).

Subsequently, the cumulative-movement-probability calculation unit 202 calculates a total movement probability, based on the baseband-derived movement probability and the acceleration-derived movement probability (refer to (c) of FIG. 5). In particular, the baseband-derived movement probability and the acceleration-derived movement probability are added up in a time-series manner, and the result of this addition is regarded as a total movement probability.

Subsequently, the cumulative-movement-probability calculation unit 202 calculates a cumulative movement probability by integrating the total movement probability over time (refer to (d) of FIG. 5). The area of a hatched region in the drawing corresponds to the cumulative movement probability.

[Positioning Management Process]

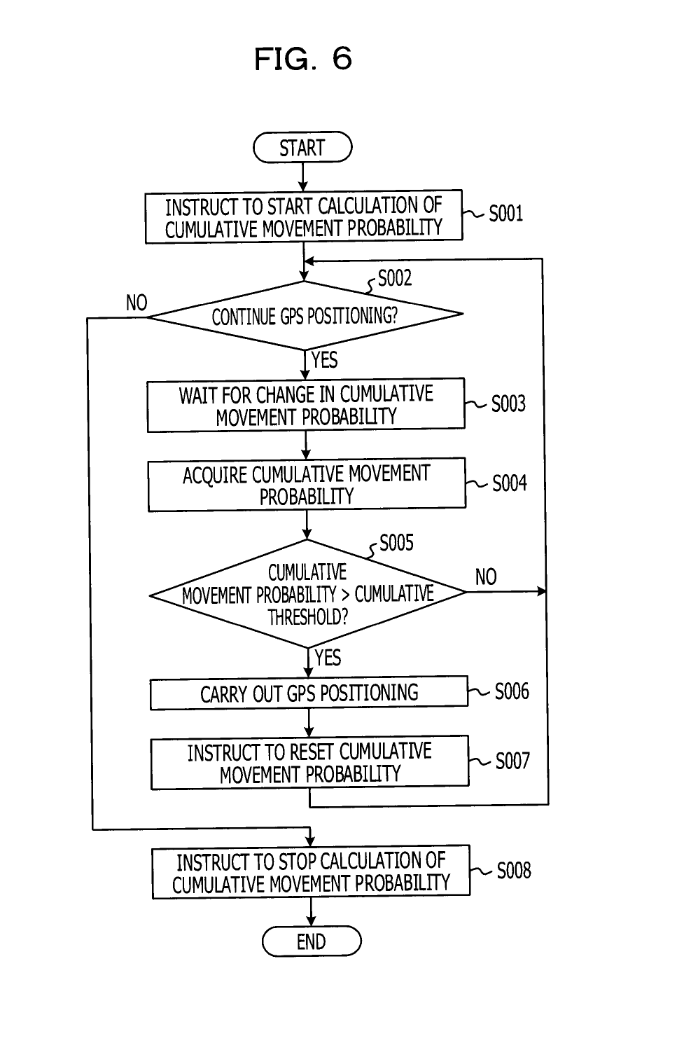

FIG. 6 is a flowchart of a positioning management process according to the first embodiment.

As illustrated in FIG. 6, based on a positioning request from an application App, for example, the positioning management unit 201 instructs the cumulative-movement-probability calculation unit 202 to start calculation of a cumulative movement probability (step S001). Based on the instruction from the positioning management unit 201, the cumulative-movement-probability calculation unit 202 starts calculation of a cumulative movement probability.

Next, the positioning management unit 201 determines whether to continue GPS positioning (step S002). In particular, the positioning management unit 201 determines whether there is an application App that is issuing a positioning request.

Here, if it is determined that GPS positioning is not to be continued (No in step S002), that is, if there is not an application App that is issuing a positioning request, the positioning management unit 201 instructs the cumulative-movement-probability calculation unit 202 to stop calculation of a cumulative movement probability (step S008), and terminates the positioning process according to this embodiment.

Otherwise, if it is determined that GPS positioning is to be continued (Yes in step S002), that is, if there is an application App that is issuing a positioning request, the positioning management unit 201 waits for a change in the cumulative movement probability (step S003).

Next, each time the cumulative movement probability calculated by the cumulative-movement-probability calculation unit 202 changes, the positioning management unit 201 acquires a cumulative movement probability after the change (step S004).

Next, the positioning management unit 201 determines whether the cumulative movement probability is larger than a cumulative threshold (step S005).

Here, if it is determined that the cumulative movement probability is not larger than the cumulative threshold (No in step S005), the positioning management unit 201 determines again whether to continue GPS positioning (step S002).

Otherwise, if it is determined that the cumulative movement probability is larger than the cumulative threshold (Yes in step S005), the positioning management unit 201 determines that the portable device 100 has moved, that is, determines that the amount of movement of the portable device 100 has reached the amount of movement at which the portable device 100 is to be caused to carry out GPS positioning, and causes the GPS driver 204 to carry out GPS positioning (step S006). That is, in this embodiment, when the cumulative movement probability is larger than the cumulative threshold, GPS positioning will be performed.

Next, the positioning management unit 201 instructs the cumulative-movement-probability calculation unit 202 to reset the cumulative movement probability (step S007). Based on the reset instruction from the positioning management unit 201, the cumulative-movement-probability calculation unit 202 will reset the cumulative movement probability. Therefore, since the cumulative movement probability will return to zero if GPS positioning is performed, it may be determined, using a cumulative movement probability from the last GPS positioning to the current point in time, whether to carry out the next GPS positioning.

Next, the positioning management unit 201 determines again whether to continue GPS positioning (step S002).

[Cumulative-Movement-Probability Calculation Process]

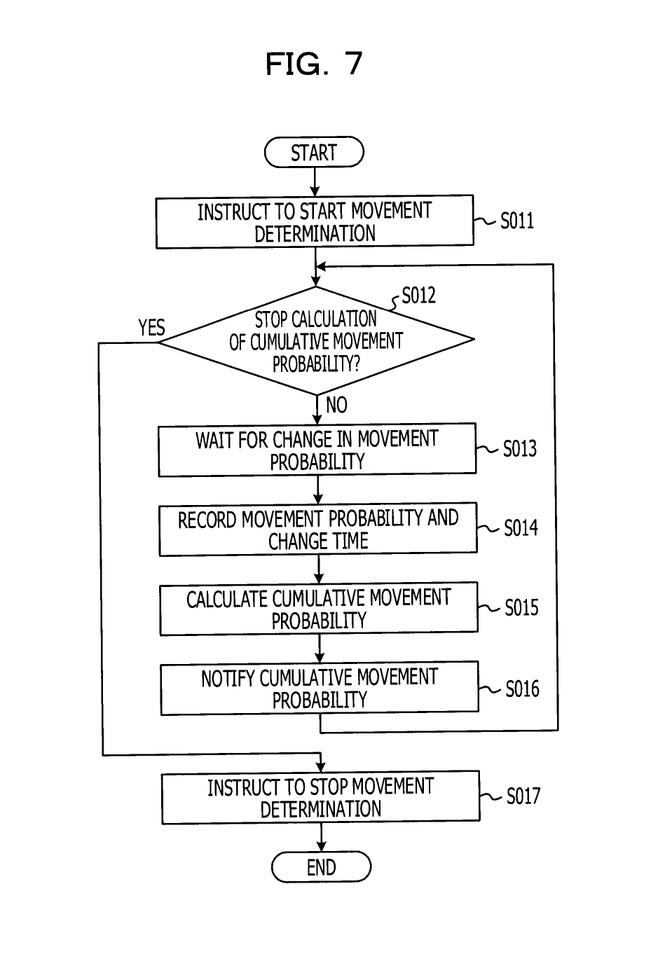

FIG. 7 is a flowchart of a cumulative-movement-probability calculation process according to the first embodiment.

As illustrated in FIG. 7, the cumulative-movement-probability calculation unit 202 instructs the first movement determination unit 203a and the second movement determination unit 203b to start movement determinations (step S011). Based on instructions from the cumulative-movement-probability calculation unit 202, the first movement determination unit 203a and the second movement determination unit 203b acquire movement determinations, that is, a baseband-derived movement determination and an acceleration-derived movement determination, respectively, for every sensor.

Next, the cumulative-movement-probability calculation unit 202 determines whether to stop calculation of a cumulative movement probability (step S012). In particular, the cumulative-movement-probability calculation unit 202 determines whether the cumulative-movement-probability calculation unit 202 has been instructed by the positioning management unit 201 to stop calculation of a cumulative movement probability.

Here, if it is determined that calculation of a cumulative movement probability is to be stopped (Yes in step S012), that is, if the cumulative-movement-probability calculation unit 202 has been instructed by the positioning management unit 201 to stop calculation of a cumulative movement probability, the cumulative-movement-probability calculation unit 202 instructs the first movement determination unit 203a and the second movement determination unit 203b to stop movement determinations (step S017), and terminates the cumulative-movement-probability calculation process according to this embodiment.

Otherwise, if it is determined that calculation of a cumulative movement probability is not to be stopped (No in step S012), that is, if the cumulative-movement-probability calculation unit 202 has not been instructed by the positioning management unit 201 to stop calculation of a cumulative movement probability, the cumulative movement probability calculation unit 202 waits for a change in the cumulative movement probabilities acquired by the first and second movement determination units 203a and 203b (step S013).

Next, each time the movement probability calculated by the first movement determination unit 203a or the second movement determination unit 203b changes, the cumulative-movement-probability calculation unit 202 acquires a movement probability after the change, and records it, together with the change time, in the time-series-movement-probability data D (step S014).

Next, the cumulative-movement-probability calculation unit 202 calculates a cumulative movement probability, based on the time-series-movement-probability data D (step S015).

Next, the cumulative-movement-probability calculation unit 202 notifies the positioning management unit 201 of the cumulative movement probability (step S016).

Next, the cumulative-movement-probability calculation unit 202 determines again whether to stop calculation of a cumulative movement probability (step S012).

According to this embodiment, whether CPS positioning is desired or not is not determined by determining whether the portable device 100 is in a “movement” state or in a “stationary” state, each time the value detected by the sensor 112 of the portable device 100 changes. Instead, based on a cumulative movement possibility, which is a time-series cumulative value of movement probabilities each of which is acquired each time the value detected by the sensor 112 changes, it is determined whether the portable device 100 has moved to the extent that GPS positioning is desired. Therefore, the “movement” of the portable device 100 within some time segment may be detected. This “movement” is overlooked by a conventional approach in which each time the value detected by the sensor 112 changes, it is determined whether the portable device 100 is in a “movement” state or in a “stationary” state. Thus, it is possible to avoid a situation in which although the portable device 100 has moved to the extent that GPS positioning is desired, this extent of movement is not recognized and GPS positioning is not carried out.

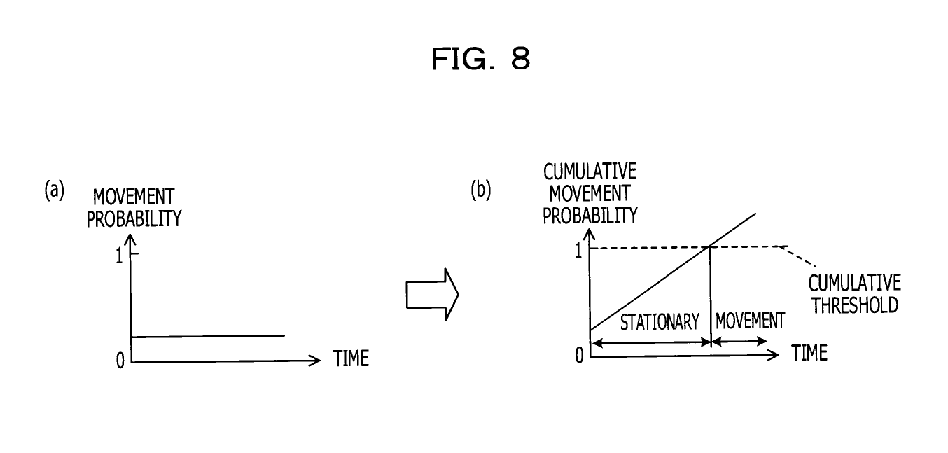

For example, in the case where the movement probability continuously has such a level that it is not able to be determined that the portable device 100 has moved, as illustrated in (a) of FIG. 8, according to a conventional approach, it is determined that the portable device 100 has not moved. However, as in this embodiment, using a cumulative movement probability, which is a time-series cumulative value of movement probabilities, it is determined that the portable device 100 has moved, as illustrated in (b) of FIG. 8.

Note that the portable device 100 may calculate a cumulative movement probability by acquiring a movement direction, as well as the movement probability, and accumulate the movement probability and the movement direction. If a cumulative movement probability is calculated in consideration of a movement direction, it may be determined more accurately whether the portable device 100 has moved. The movement direction may be acquired, for example, from the sensor 112.

(Modifications)

In this embodiment, the baseband-derived movement probability and the acceleration-derived movement probability are added up, and the result of this addition is regarded as a total movement probability. However, the present disclosure is not limited to this.

For example, the average of the baseband-derived movement probability and the acceleration-derived movement probability may be regarded as a total movement probability. Although not limited in particular, expression (1), for example, may be used as an expression for calculating a total movement probability. Note that “P”, “P₁”, and “P₂” in the expression are a total movement probability, a baseband-derived movement probability, and an acceleration-based movement probability, respectively.

$$P = \frac{( {P}_{1} + {P}_{2} )}{2} \qquad ( 1 )$$

In addition to this, if both of the baseband-derived movement probability and the acceleration-based movement probability are larger than a threshold determined in advance, the total movement probability may be set to be larger than the total sum of the baseband-derived movement probability and the acceleration-based movement probability. Although not limited in particular, expression (2), for example, may be used as an expression for calculating a total movement probability according to this modification. Note that “P”, “P₁”, and “P₂” in the expression are a total movement probability, a baseband-derived movement probability, and an acceleration-based movement probability, respectively.

P=1−{(1−P₁)×(1−P₂)} (2)

However, if P₁, P₂>0.2, expression (2) is to be used, and otherwise, expression (1) is to be used.

When expression (2) is used, it is found that if both of the baseband-derived movement probability and the acceleration-based movement probability exceed 0.2, the total movement probability is larger than the average of the baseband-derived movement probability and the acceleration-based movement probability.

Also, although, in this embodiment, the cumulative movement probability is calculated based on the baseband-derived movement probability and the acceleration-based movement probability, the present disclosure is not limited to this. Any sensor-derived movement probability may be used as long as it is a movement probability acquired from the value detected by the sensor 112.

Additionally, although, in this embodiment, GPS positioning is used for acquisition of position information of the portable device 100, the present disclosure is not limited to this. For example, Wi-Fi positioning, baseband positioning, and other positioning may be used.

Also, the expression for calculating a cumulative movement probability according to this embodiment is not limited particularly. Since the cumulative movement probability is a probability that movement of the portable device 100 has occurred in a period from a point in time t₀ at which calculation of a cumulative movement probability starts to the current point in time t₁, assuming that the movement probability at the current point in time t₁ is P(t), the cumulative movement probability Pₛᵤₘ may be expressed by expression (3).

Pₛᵤₘ=f(t₀,t₁,P(t) (3)

Although not limited in particular, expression (4) or (5), for example, may be used for function expression f for calculating a cumulative movement probability.

$$\begin{matrix}f ( {t}_{0} , {t}_{1} , P ( t ) ) = {\int }_{{t}_{0}}^{{t}_{1}} P ( t ) d t & ( 4 ) \\ f ( {t}_{0} , {t}_{1} , P ( t ) ) = 1 - {\prod }_{t = {1}_{0}}^{{t}_{1}} ( 1 - P ( t ) ) & ( 5 )\end{matrix}$$

### Second Embodiment

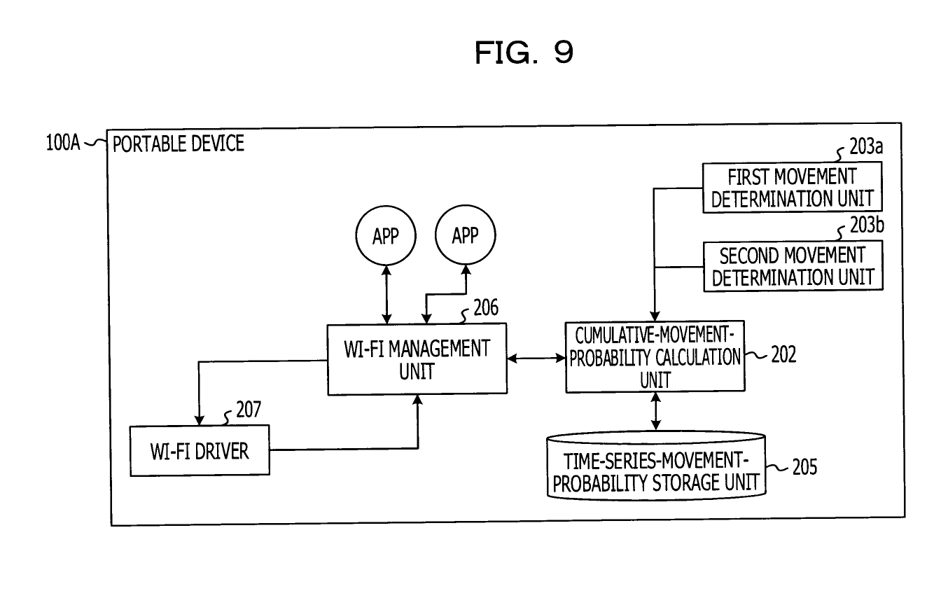

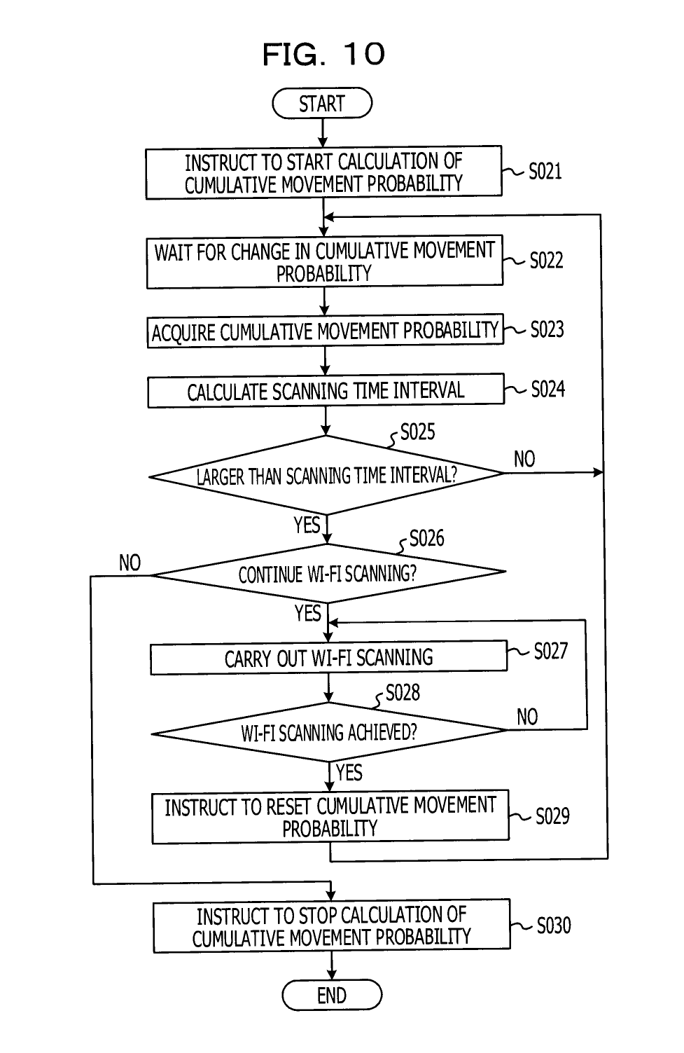

With reference to FIG. 9 and FIG. 10, a second embodiment will be described below. However, here, description of configurations, functions, and advantages equivalent to those in the first embodiment is omitted.

In the first embodiment, a cumulative movement probability is used in order to determine whether to carry out GPS positioning; however, in this embodiment, a cumulative movement probability is used in order to determine whether to carry out search for an access point, that is, Wi-Fi scanning. Additionally, an application App according to this embodiment issues a request for search for an access point, that is, a request for scanning, not a request for positioning.

[Functional Blocks of Portable Device 100A]

FIG. 9 is a schematic diagram of functional blocks of a portable device 100A according to a second embodiment.

As illustrated in FIG. 9, the portable device 100A according to this embodiment includes a Wi-Fi management unit 206 and a Wi-Fi driver 207 that are instead of the positioning management unit 201 and the GPS driver 204, respectively.

Both of the Wi-Fi management unit 206 and the Wi-Fi driver 207 are implemented in such a way that the CPU 101 loads a control program into the main memory 102 and executes the control program loaded into the main memory 102.

The Wi-Fi management unit 206 calculates a time interval between Wi-Fi scans, that is, a scanning time interval, based on a cumulative movement probability acquired from the cumulative-movement-probability calculation unit 202. Although not limited in particular, expression (6), for example, may be used as an expression for calculating a scanning time interval. Note that “A” and “α” in the expression are arbitrary constants.

Scanning time interval=A/(cumulative movement probability+α) (6)

When expression (6) is used, it is found that the larger the cumulative movement probability, the shorter the scanning time interval, and the smaller the cumulative movement probability, the longer the scanning time interval.

Additionally, the Wi-Fi management unit 206 instructs, based on a scanning time interval, the Wi-Fi driver 207 to carry out Wi-Fi scanning. Based on the issuance status of a scanning request of an application App, the Wi-Fi management unit 206 also instructs the Wi-Fi driver 207 to stop operation of the Wi-Fi module 110. Additionally, the Wi-Fi management unit 206 notifies the application App of access point information and so on acquired from the Wi-Fi driver 207.

The Wi-Fi driver 207 turns on or off the Wi-Fi module 111, based on an instruction for start or stop of operation from the Wi-Fi management unit 206. Additionally, the Wi-Fi driver 207 notifies the Wi-Fi management unit 206 of access point information acquired by the Wi-Fi module 110.

[Wi-Fi Management Process]

FIG. 10 is a flowchart of a Wi-Fi management process according to the second embodiment.

As illustrated in FIG. 10, based on a scanning request from an application App, for example, the Wi-Fi management unit 206 instructs the cumulative-movement-probability calculation unit 202 to start calculation of a cumulative movement probability (step S021). Based on the instruction from the Wi-Fi management unit 206, the cumulative-movement-probability calculation unit 202 starts calculation of a cumulative movement probability.

Next, the Wi-Fi management unit 206 waits for a change in the cumulative movement probability (step S022).

Next, each time the cumulative movement probability calculated by the cumulative-movement-probability calculation unit 202 changes, the Wi-Fi management unit 206 acquires a cumulative movement probability after the change (step S023).

Next, based on the cumulative movement probability, the Wi-Fi management unit 206 calculates a scanning time interval (step S024).

Next, the Wi-Fi management unit 206 determines whether a period of time elapsed from the previous Wi-Fi scanning is larger than the scanning time interval (step S025).

Here, if it is determined that the period of time elapsed from the previous Wi-Fi scanning is not larger than the scanning time interval (No in step S025), the Wi-Fi management unit 206 determines that the access point status around the portable device 100A has not changed, and waits for a change in the cumulative movement probability (step S022).

Otherwise, if it is determined that the period of time elapsed from the previous Wi-Fi scanning is larger than the scanning time interval (Yes in step S025), the Wi-Fi management unit 206 determines whether to continue Wi-Fi scanning (step S026). In particular, the Wi-Fi management unit 206 determines whether there is an application App that is issuing a positioning request.

Here, if it is determined that Wi-Fi scanning is not to be continued (No in step S026), that is, if there is not an application App that is issuing a scanning request, the Wi-Fi management unit 206 instructs the cumulative-movement-probability calculation unit 202 to stop calculation of a cumulative movement probability (step S030), and terminates the Wi-Fi management process according to this embodiment.

Otherwise, if it is determined that Wi-Fi scanning is to be continued (Yes in step S026), that is, if there is an application App that is issuing a scanning request, the Wi-Fi management unit 206 determines that the access point status around the portable device 100A has changed, and causes the Wi-Fi driver 207 to carry out Wi-Fi scanning (step S027).

Next, the Wi-Fi management unit 206 determines whether Wi-Fi scanning has been achieved (step S028). In particular, the Wi-Fi management unit 206 determines whether access point information has been acquired.

Here, if it is determined that Wi-Fi scanning has not been achieved (No in step S028), the Wi-Fi management unit 206 causes the Wi-H driver 207 to carry out Wi-Fi scanning again (step S027).

Otherwise, if it is determined that Wi-Fi scanning has been achieved (Yes in step S028), the Wi-Fi management unit 206 instructs the cumulative-movement-probability calculation unit 202 to reset the cumulative movement probability (step S029). Based on the instruction for resetting from the positioning management unit 201, the cumulative-movement-probability calculation unit 202 resets the cumulative movement probability.

Next, the Wi-Fi management unit 206 waits for a change in the cumulative movement probability again (step S022).

According to this embodiment, a cumulative movement probability is used in order to determine whether to cause Wi-Fi scanning to be carried out. Therefore, the “movement” of the portable device 100 within some time period may be detected. This “movement” is overlooked by a conventional approach in which each time the value detected by the sensor 112 is acquired, it is determined whether the portable device 100A is in a “movement” state or in a “stationary” state. Thus, it is possible to avoid a situation in which although the portable device 100A has moved to the extent that Wi-Fi scanning is desired, this extent of movement is not recognized and Wi-Fi scanning is not carried out.

### Third Embodiment

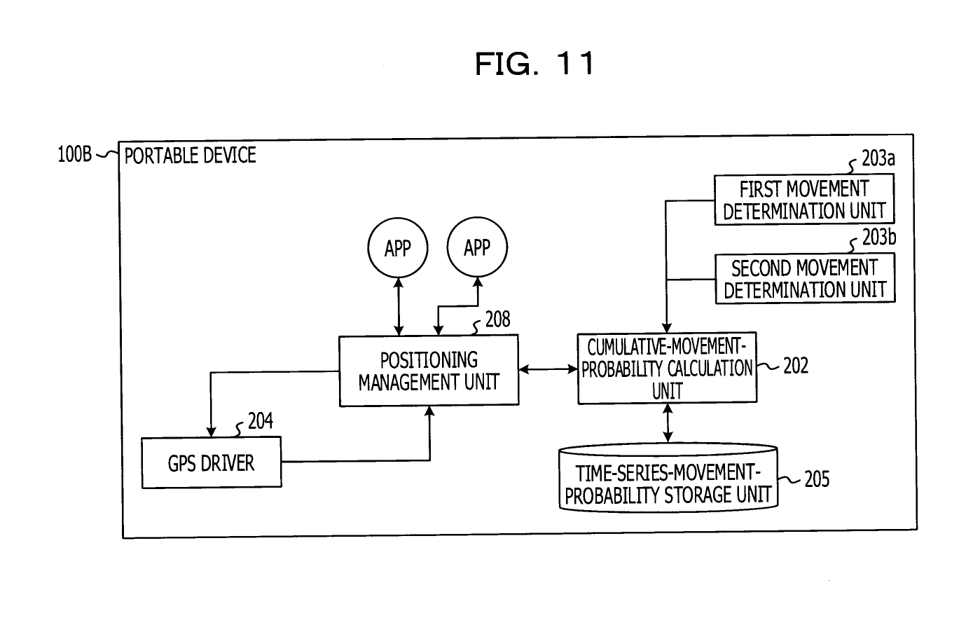

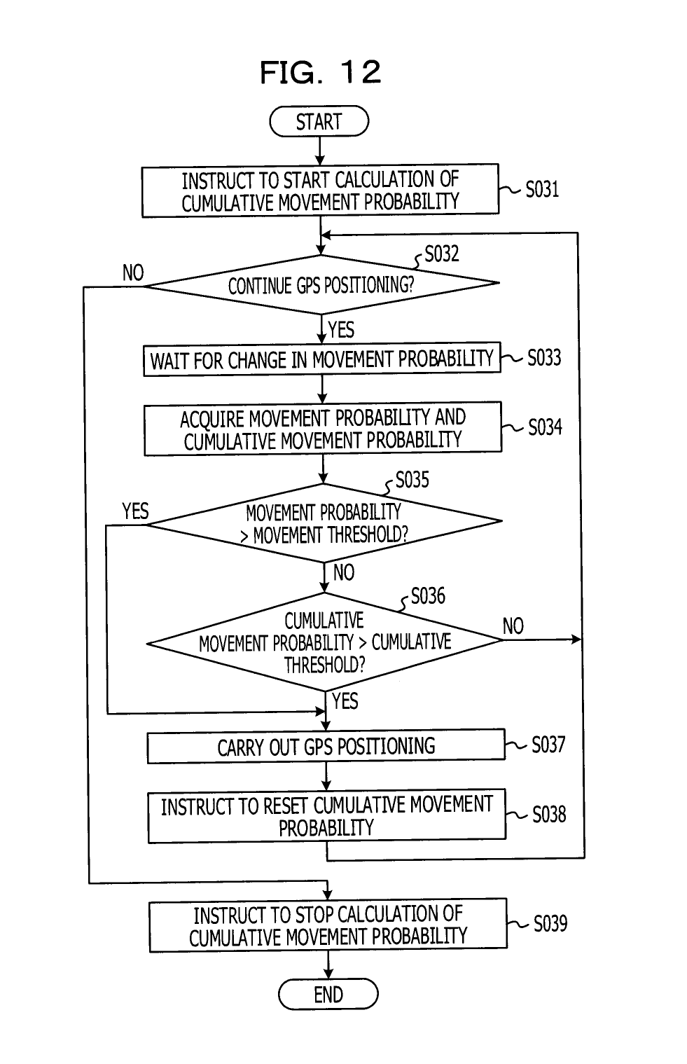

With reference to FIG. 11 and FIG. 12, a third embodiment will be described below. However, here, description of configurations, functions, and advantages equivalent to those in the first embodiment is omitted.

While the positioning management unit 201 according to the first embodiment determines, based on a cumulative movement probability, whether to instruct the GPS driver 204 to start operation of the GPS module 111, the positioning management unit 201 according to this embodiment determines, based on both of a movement probability and a cumulative movement probability, whether to instruct the GPS driver 204 to start operation of the GPS module 111.

[Functional Blocks of Portable Device 100B]

FIG. 11 is a schematic diagram of functional blocks of a portable device 100B according to a third embodiment.

As illustrated in FIG. 11, the portable device 100B according to this embodiment includes a positioning management unit 208 instead of the positioning management unit 201 according to the first embodiment. The positioning management unit 208 is implemented in such a way that the CPU 101 loads a control program into the main memory 102 and executes the control program loaded into the main memory 102.

The positioning management unit 208 determines whether movement probabilities from the first and second movement determination units 203a and 203b are larger than a movement threshold. Additionally, if the movement probabilities are larger than the movement threshold, the positioning management unit 208 instructs the GPS driver 204 to carry out GPS positioning regardless of the evaluation value of a cumulative movement probability.

[Positioning Management Process]

FIG. 12 is a flowchart of a positioning management process according to the third embodiment.

As illustrated in FIG. 12, in response to a positioning request from an application App, for example, the positioning management unit 208 instructs the cumulative-movement-probability calculation unit 202 to start calculation of a cumulative movement probability (step S031). In response to the instruction from the positioning management unit 208, the cumulative-movement-probability calculation unit 202 starts calculation of a cumulative movement probability.

Next, the positioning management unit 208 determines whether to continue GPS positioning (step S032). In particular, the positioning management unit 208 determines whether there is an application App that is issuing a positioning request.

Here, if it is determined that GPS positioning is not to be continued (No in step S032), that is, if there is not an application App that is issuing a positioning request, the positioning management unit 208 instructs the cumulative-movement-probability calculation unit 202 to stop calculation of a cumulative movement probability (step S039), and terminates the positioning process according to this embodiment.

Otherwise, if it is determined that GPS positioning is to be continued (Yes in step S032), that is, if there is an application App that is issuing a positioning request, the positioning management unit 208 waits for a change in the movement probability (step S033).

Next, each time the movement probability calculated by either of the first and second movement determination units 203a and 203b changes, the positioning management unit 208 acquires a movement probability and a cumulative movement probability after the change (step S034).

Next, the positioning management unit 208 determines whether the movement probability is larger than a movement threshold (step S035).

Here, if it is determined that the movement probability is not larger than the movement threshold (No in step S035), then the positioning management unit 208 determines whether the cumulative movement probability is larger than a cumulative threshold (step S036).

Here, if it is determined that the cumulative movement probability is not larger than the cumulative threshold (No in step S036), the positioning management unit 208 determines again whether to continue GPS positioning (step S032).

Otherwise, if it is determined that the cumulative movement probability is larger than the cumulative threshold (Yes in step S036), and if it is determined that the movement probability is larger than the movement threshold (Yes in step S035), the positioning management unit 208 determines that the portable device 100B has moved, that is, determines that the amount of movement of the portable device 100B has reached the amount of movement at which the portable device 100B is caused to carry out GPS positioning, and causes the GPS driver 204 to carry out GPS positioning (step S037). That is, in this embodiment, even when the cumulative movement probability is not larger than the cumulative threshold, GPS positioning will be performed if the movement probability is larger than the movement threshold.

Next, the positioning management unit 208 instructs the cumulative-movement-probability calculation unit 202 to reset the cumulative movement probability (step S038). The cumulative-movement-probability calculation unit 202 resets the cumulative movement probability, based on the reset instruction from the positioning management unit 208.

Next, the positioning management unit 208 determines again whether to continue GPS positioning (step S032).

According to this embodiment, if the movement probability is larger than the movement threshold, GPS positioning is carried out regardless of the cumulative movement probability. Therefore, if the movement probability is sufficiently high at a moment in time, GPS positioning may be carried out, without waiting until the cumulative movement probability exceeds the cumulative threshold.

Note that while, in this embodiment, a determination of whether the movement probability is larger than the movement threshold is made by the cumulative-movement-probability calculation unit 202, the determination is not limited to this. For example, the determination of whether the movement probability is larger than the movement threshold may be made by either of the first and second movement determination units 203a and 203b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A portable device comprising:
a memory; and
a processor coupled to the memory and configured to:
determine whether to perform a process of acquiring information from an external device, based on values of a plurality of indices related to movement of the portable device acquired at different points in time.

2. The portable device according to claim 1, wherein the processor is configured to:
accumulate the values of the plurality of indices, and
determine whether to perform the process of acquiring information from the external device.

3. The portable device according to claim 2, wherein the processor is configured to:
perform the process of acquiring information from the external device if the accumulated value is larger than a threshold.

4. The portable device according to claim 1, wherein
the plurality of indices are acquired by a plurality of different devices.

5. The portable device according to claim 1, wherein
the information acquired from an external device is at least either information sent from a GPS satellite or information sent from a wireless access point.

6. A method of controlling a portable device, comprising:
determining whether to perform a process of acquiring information from an external device, based on a value of a first index related to movement of the portable device and a value of a second index related to movement of the portable device, the second index being different from the first index.

7. The method according to claim 6, further comprising:
accumulating the values of the plurality of indices; and
determining whether to perform the process of acquiring information from the external device.

8. The method according to claim 7, further comprising:
performing the process of acquiring information from the external device when the accumulated value is larger than a threshold.

9. The method according to claim 6, wherein
the plurality of indices are acquired by a plurality of different devices.

10. The method according to claim 1, wherein
the information acquired from an external device is at least either information sent from a GPS satellite or information sent from a wireless access point.
